(19) United States
(12) Patent Application Publication
(10) Pub. No.: US 2007/0139513 A1
(43) Pub. Date: Jun. 21, 2007

(54) Video telephone soft client with a mobile phone interface

(76) Inventor: Zheng Fang, Round Lake, IL (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/303,266

(22) Filed: Dec. 16, 2005

(51) Int. Cl. H04N 7/14

(52) U.S. Cl. 348/14.01

(57) ABSTRACT

A videophone soft client running on an electronic device such as a personal computer or set top box includes an interface with a mobile phone having a built-in camera. The mobile phone serves as a multi-functional peripheral device to capture video and audio and provide wireless data network access to the electronic device to thereby enable a video telephony experience for a user.

### BACKGROUND

Video telephony in the past required the use of expensive specialized equipment and associated high-bandwidth transport services such as ISDN (Integrated Services Digital Network) on the traditional public switched telephone network. As a result, video telephony was often consigned as a high-end niche application that was mostly used in the business world for events such as videoconferencing. Videoconferencing equipment was complex and often required an IT (information technology) staffer to set it up and operate. In mass market applications, less costly video telephony equipment using regular telephone lines often required users to accept significant compromises in video quality. Video frame rates as low as a single to ten frames per second and substantial video latency left a lot of video telephone (often called simply “videophones”) sitting unused once the initial novelty of the device wore off.

Technology problems facing video telephony are steadily being solved. In particular, as broadband Internet access has become more widespread, sufficient bandwidth to the home and office is available to support much higher quality video. Both new and existing carriers now provide packet-based services called “voice-over-Internet Protocol” (VoIP) that serve as the foundation for both voice and video telephony. Using the ITU (International Telecommunications Union) recommendation H.323 or SIP (Session Initiation Protocol) developed by the IETF ((Internet Engineering Task Force), VoIP has given rise to video telephony on an ad-hoc, on-demand basis where video calls are inexpensive, reliable and as easy to make as a regular voice call.

Current video telephony devices include dedicated hardware-enabled H.323/SIP desktop videophones and videophones that are implemented using a software client (often simply called a “soft client”) that runs on a general purpose PC (personal computer). In both cases, video telephony users may generally access similar call control features that they are familiar with for audio calls including call hold, transfer, mute, speed-dialing, phonebook dialing, buddy-list dialing (where calls are made to persons who the system identifies as being “online” and available to participate in a video call), and three-way and conference calling. Some video telephony devices are configured to allow a video message to be left when the called party does not answer.

Videophone soft clients use the video processing capabilities that are already built-in to a PC to render the video images used in a videophone call. In addition, most videophone soft clients use a graphical user interface (“GUI”) that is displayed in a window on the PC's display screen. The GUI provides such things as a number keypad, and menus and buttons to facilitate the set up and control of a videophone call. Videophone soft clients may also provide APIs (applications programming interfaces) that enable video telephony features to be integrated into other desktop applications such as word processing and email. Using the GUI, users may simply dial a number to initiate a video call much like they would when using any telephone. Accordingly, PC-based video telephony has improved productivity and the ability to communicate in both the home and workplace environments.

Videophone soft clients must be combined with built-in computer hardware and/or peripheral hardware—including a microphone, speaker and camera—to provide a PC with video telephony functionality. While many PCs include built-in speakers and microphones, users often prefer to add peripheral hardware such as a headset and microphone to improve the video telephony experience or enhance privacy. Fortunately, the consumer demand for cameras and other peripheral hardware is great enough to make video telephony using a PC very affordable.

While the availability of low-priced PCs and peripheral hardware is a positive factor influencing more widespread use of video telephony, users are still faced with obstacles in getting their PCs properly configured to function as a videophone. After a videophone soft client is installed, a user must plug the peripheral hardware into the correct port on the PC. As noted above, this hardware includes the camera and may additionally include a speaker and microphone, or a headset. In addition, the user must ensure that the hardware (both built-in and external hardware) is properly recognized by the PC's operating system and the soft client application. This often requires that the appropriate device driver is installed on the PC and that the hardware settings are correct for the application. Lastly, the PC needs to be set up to access a wired or wireless broadband connection such as DSL (Digital Subscriber Line) or cable using a modem or LAN (local area network).

For many users, this set of tasks can be daunting and cumbersome. Even for experienced users, the steps required to initiate or participate in a video telephony session can often be inconvenient. For example, laptop PC users who want to use their computers as videophones while traveling would appreciate a quick and easy way to get set up without needing to carry extra equipment.

### BRIEF DESCRIPTION OF THE DRAWINGS

FIG. 1 is a simplified pictorial representation of an illustrative mobile phone incorporating a built-in camera and an accessory connector;

FIG. 2 is top view of the mobile phone shown in FIG. 1;

FIG. 3 is front view of the mobile phone shown in FIG. 1;

FIG. 4 is a back view of the mobile phone shown in FIG. 1;

FIG. 5 is a simplified diagram of an illustrative accessory and device connector arrangement used to connect a mobile phone to an electronic device hosting a videophone soft client;

FIG. 6 shows front views of the connectors shown in FIG. 5;

FIG. 7 shows a cutaway view of an illustrative accessory connector disposed within the body of a mobile phone;

FIG. 8 is a simplified pictorial representation of the illustrative arrangement in which the mobile phone in FIG. 1 is connected to a laptop PC which hosts a videophone soft client using a cable;

FIG. 9 is block diagram of an illustrative example of a client-server arrangement incorporating a head-end server, network, set top box, remote control, mobile telephone and television;

FIG. 10 is a simplified pictorial representation of the illustrative arrangement in which the mobile phone shown in FIG. 1 is connected to a set top box which hosts a videophone soft client;

FIG. 11 is a top pictorial view of an illustrative mobile phone stand incorporating a device connector;

FIG. 12 is a simplified pictorial representation of the illustrative arrangements shown in FIGS. 10 and 11 as used with a television;

FIG. 13 is a simplified pictorial representation of a first illustrative graphical user interface window that is used to facilitate user operation of a soft videophone;

FIG. 14 is a simplified pictorial representation of a second illustrative graphical user interface window that is used to facilitate user operation of a soft videophone; and

FIG. 15 is a diagram of an illustrative architecture for a videophone soft client.

### DETAILED DESCRIPTION

Many of the current obstacles with soft clients used to implement video telephony on PCs and other electronic devices are overcome by an illustrative arrangement where a mobile phone having a built-in camera functions as a multi-functional peripheral device to capture video and audio and provide wireless data network access to the PC to thereby enable a video telephony experience. Users simply plug their camera phones into a free device port in the PC (such as Universal Serial Bus or “USB” port) and a soft client running on the PC utilizes the phone's camera, microphone and network access functions to turn the PC into a fully functional “soft” videophone.

The videophone soft client supports a graphical user interface on the PC's display that enables a user to make and receive videophone calls and set up the videophone to meet specific requirements and preferences. In some applications, a wireless headset/microphone is used to provide an enhanced video telephony session or to give additional privacy. While connected to the PC, the mobile phone's battery is also recharged.

Accordingly, such an illustrative arrangement provides a very convenient way to gain the benefits of video telephony using equipment that many users already have on hand. For example, business travelers commonly carry a laptop PC, mobile camera phone and wireless headset with microphone. Using the soft client with a mobile phone interface, such users can quickly set up a videophone call in any of the many areas covered by wireless data networks.

In another example, a set top box is commonly used in a home or hotel room to access a broadband network for cable television or other services. A user simply plugs a mobile phone into a set top box on which a soft client with a mobile phone interface is running to make videophone calls using the broadband network connection. Voice commands to the mobile phone are used (using the mobile phone's existing voice recognition interface) to control the display of video showing the local and/or remote call participants on a television or display device that is typically coupled to the set top box.

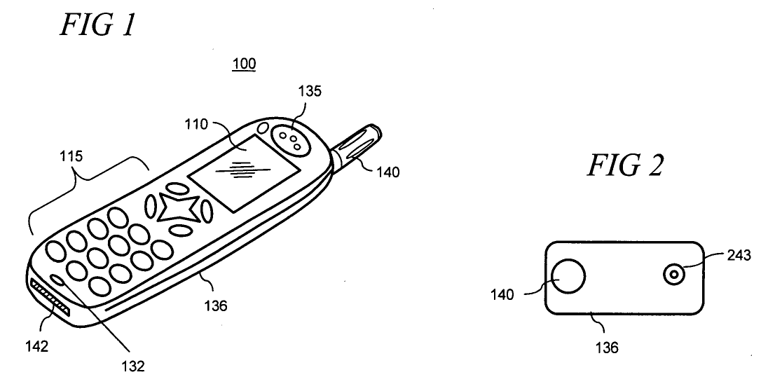

FIG. 1 is a simplified pictorial representation of an illustrative mobile telephone 100. The term “mobile phone” generally refers to portable telephone devices using wireless radio wave transmission technology. In an illustrative example of videophone soft client with mobile phone interface as described in detail herein, the mobile phone 100 is arranged with multiple functionalities beyond voice telephony. Mobile phone 100 is thus representative of current trends in mobile phone technology by supporting a variety of functionalities including, for example, stereo audio, video capture and display, still picture capture and display and data services such as short message service (“SMS”), email and Internet browsing. Mobile phone 100 is also configured to be utilized as an external modem for wireless data network access. Accordingly, mobile phone 100 includes the necessary hardware, software and firmware used to implement the functionalities described above.

Mobile phone 100 includes a display screen 110, keys 115, microphone 132 (having an access opening below the keys, as shown) and speaker 135 that are disposed in and along the body 136 of mobile phone 100. Mobile phone 100 is also equipped with an external antenna 140 as is common with many mobile phone designs. Mobile phone 100 is an example of a non-flip-type phone in common use which is often called a “candy bar” style phone. It is emphasized, however, that mobile phones with other form factors are equally suitable to interface with the present videophone soft client. For example, “flip” phones that typically have a pivoting display screen to allow the mobile phone to fold compactly may also be used. And, other form factors and arrangements are usable so long as the mobile phone includes a camera that is capable of capturing video images.

An accessory connector 142 is typically positioned along one of the surfaces of the mobile phone, in this case along the bottom portion of mobile phone 100. The accessory connector 142 is commonly used to connect mobile phones to external accessories. Such accessories include, for example, speakers, data cables, chargers, hands-free car kits, and the like. In this illustrative example, accessory connector 142 is used to operatively couple with a corresponding connector disposed at the end of connecting cable or mobile phone stand (as shown and described below) to facilitate a connection between the mobile phone and a electronic device such as a PC or set top box which hosts the videophone soft client.

FIG. 2 is a top view of mobile phone 100. A jack 243 is disposed along the top portion of the body 136 of mobile phone 100 along with antenna 140. Jack 243, in this illustrative example, is a stereo audio jack which is designed to engage with a plug of a stereo headset (not shown) such as the common 2.5 or 3.5 mm mobile phone plugs. In some application, audio jack 243 is configured as a three channel jack so that an external microphone may be used in addition to supporting stereo audio output. In addition, headsets incorporating microphones that use a single three conductor plug are widely available.

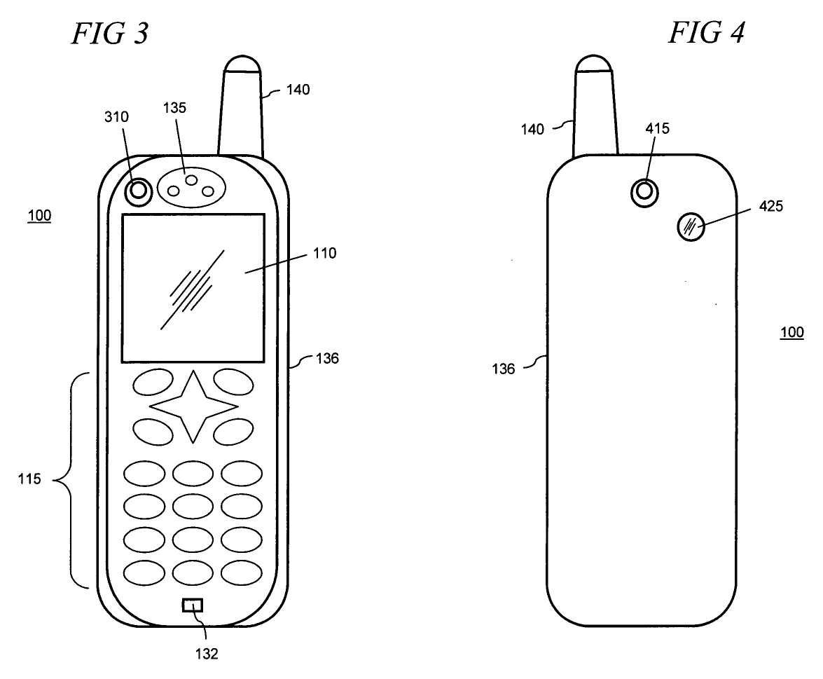

FIG. 3 is a front view of mobile phone 100 showing the objective for a screen side camera 310. That is, camera 310 is built in to mobile phone 100 so that its objective is on the screen side (i.e., front side) of mobile phone 100. This orientation allows self portraits to be readily taken given that most mobile phones use the display screen (110 in FIGS. 1, 2 and 3) as the camera viewfinder. Camera 310 is also used in video telephony applications where the mobile phone 100 is used as a standalone videophone. In such a case, camera 310 captures the user while screen 110 displays the video image of the user at the remote end of the video call.

Camera 310 is representative of current mobile phone camera technology where the general capabilities and picture quality of the built-in mobile phone cameras approach that of purpose built digital cameras. Mobile phone cameras having three, four, five or even higher count megapixel imaging sensors are becoming more commonplace. Along with increasingly dense image storage space, mobile phone cameras are displacing many low- and medium-end purpose-built digital cameras in the market.

Camera 310, being a digital imaging device, is capable of capturing both still and moving ( i.e, video) images. Common formats for video imaging that are used in various applications of a videophone soft client with a mobile phone interface are listed at the end of this description.

FIG. 4 is a back view of mobile phone 100 showing a rear facing camera objective 415 and a flash 425. In some mobile phones camera objective 415 is coupled to the same imaging sensor, such as a CCD (charge-coupled device) or APS (active pixel sensor), as camera objective 310. In other mobile phones, more than one imaging sensor is used when multiple camera objectives are provided. In the description that follows “camera 310” shall refer to an imaging sensor disposed in mobile phone 100 using the screen side objective unless otherwise indicated.

A user typically uses the rear facing camera objective 415 for snapshots and video of subjects or scenery in front of the user. In such a case the screen 110 functions as the viewfinder for mobile phone camera. The flash 425 functions conventionally to provide additional lighting when necessary to achieve appropriate still and video image exposure.

Some mobile phones are equipped with wireless I/O (input/output) capabilities. Bluetooth is one common example of a wireless radio frequency (“RF”) communication feature that enables users to employ wireless microphones and headsets with their mobile phones, among other accessories or peripheral devices. Other common wireless formats include Institute of Electrical and Electronic Engineers, IEEE 802.11, ultra wideband wireless (“UWB”), magnetic and infrared (“IR”) links. In some cases, wireless communication is used to connect a mobile phone with other mobile phones, PCs, and personal digital assistant (PDA) type devices, to exchange data such as phone or address book data.

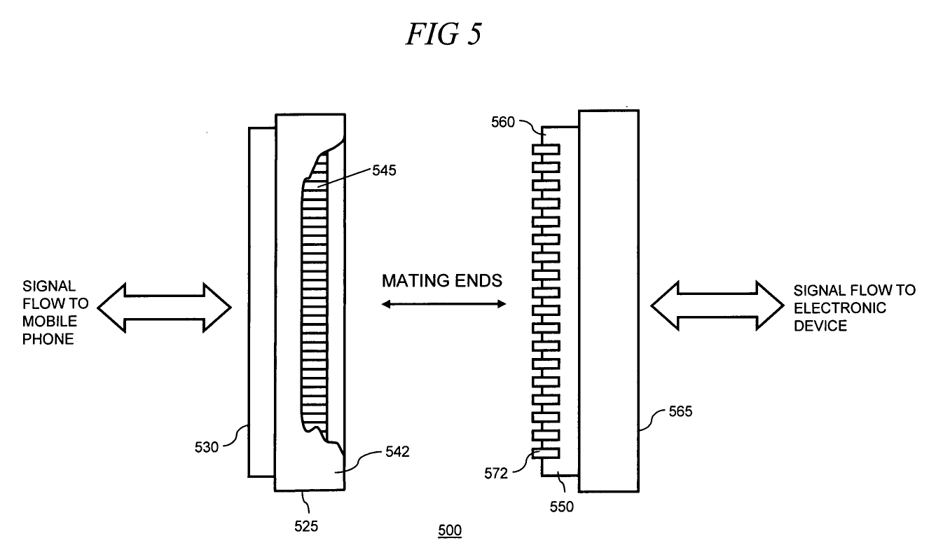

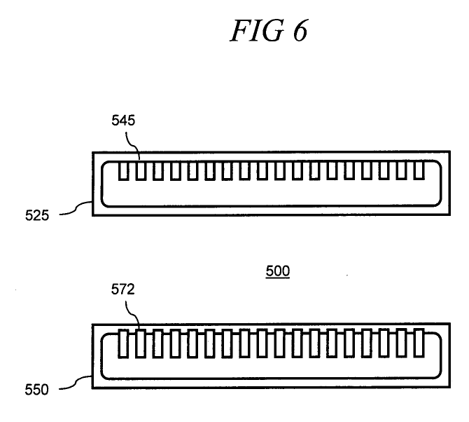

FIG. 5 is a simplified diagram of an illustrative accessory connector arrangement 500 used to connect a mobile phone to an electronic device such as a PC or set top box that is used to host a videophone soft client with mobile phone interface. FIG. 6 shows front views of the connectors in the connector arrangement 500.

The connector arrangement 500 comprises two mating connectors. The mobile phone's accessory connector 525 has a circuit end 530 that is arranged to be coupled to electrical circuits in a mobile phone, including for example, battery circuitry and I/O control circuitry. Accessory connector 525 has mating end 542 that is arranged to mate with a corresponding device connector 550. Device connector 550 has a mating end 560 and a circuit end 565 that is arranged to be coupled to electrical circuitry in an electronic device. In many applications of the present videophone soft client the device connector 550 is coupled to one end of a communications cable, the other end of which is then connected to the electronic device using a conventional connector (as described below).

The connector arrangement 500 used to connect a mobile phone to the electronic device which hosts the videophone soft client with mobile phone interface may be widely varied. Thus, the physical form factor, connector count and configuration of connector arrangement are typically a matter of design choice for the specific application involved. However, in this illustrative example, connector arrangement 500 includes both power and data contacts. Accessory connector 525 includes a set of contacts 545 which are arranged to engage with corresponding and mating contacts 572 in device connector 550. Accordingly, individual contacts in contact set 545 of accessory connector 525 used for power transmission are operatively coupled to battery circuitry in the mobile phone. Individual contacts in contact set 545 used for data transmission are operatively coupled, for example, to the mobile phone's I/O controller circuitry. In addition, then, the power and data contacts in contact set 545 are configured to engage with corresponding contacts in contact set 572 in device connector 550 so as to provide operational or charging power and data transmission between the mobile phone and the electronic device when the connectors 525 and 550 are mateably engaged. Alternative data interface formats are listed at the end of this description.

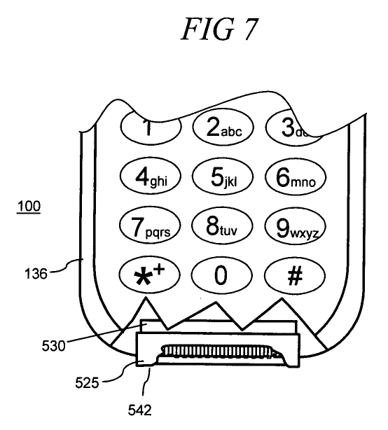

In the illustrative example shown in FIGS. 6 and 7, the contact set 572 in device connector 550 protrude for insertion into the corresponding contacts 545 that are recessed within connector 525 (i.e., a “male” to “female” connection). In some applications, contact set 572 and connector 550 are arranged to snugly fit (i.e., a “friction-fit”) with contact set 545 and connector 525 to hold the connector arrangement 500 together. Alternatively, connectors 525 and 550 may include a locking mechanism for positively locking the connectors together. For example, a latch on a portion of one connector that engages and disengages with a portion of the other connector may be used in some applications.

The arrangement of contacts in connector arrangement 500 may also be widely varied. For example, data transmission functionalities including USB (Universal Serial Bus), IEEE-1394 (commonly called “FireWire”) and other data transmission standards are selected to meet specific requirements. Functionalities may be mixed and combined as well in some applications so that some contacts in the contact sets are dedicated to USB signals while others are dedicated to FireWire signals. Conventional signals including grounding, charging, powering, signaling protocols, device or accessory identification and similar signals may also be carried across the contacts sets. Accordingly, the number of contacts and their physical configuration will vary according to the specific requirements of an application.

FIG. 7 is a cutaway view of an accessory connector 525 that is disposed within the body 136 of the illustrative mobile phone 100. The accessory connector in this example is positioned in the body 136 so that the circuit end 530 is available to circuitry contained internally within mobile phone 100. The mating end 542 is positioned so that it is exposed on an external surface (in this example, the bottom portion of mobile phone 100) to thereby facilitate mateable engagement with a respective corresponding device connector. One example of an accessory connector suitable for many applications is the connector from the “iDEN” brand family of products produced by Motorola®, and more specifically part number 0985678E02.

Device connector 550, in one illustrative example, is coupled to one end of a communications cable to facilitate connection between a mobile phone and an electronic device, as noted above. The other end of the cable includes a connector conforming to one of a variety of conventional forms including USB, FireWire, parallel, serial, and SCSI (Small Computer System Interface). Other alternative cable connectors are listed at the end of this description.

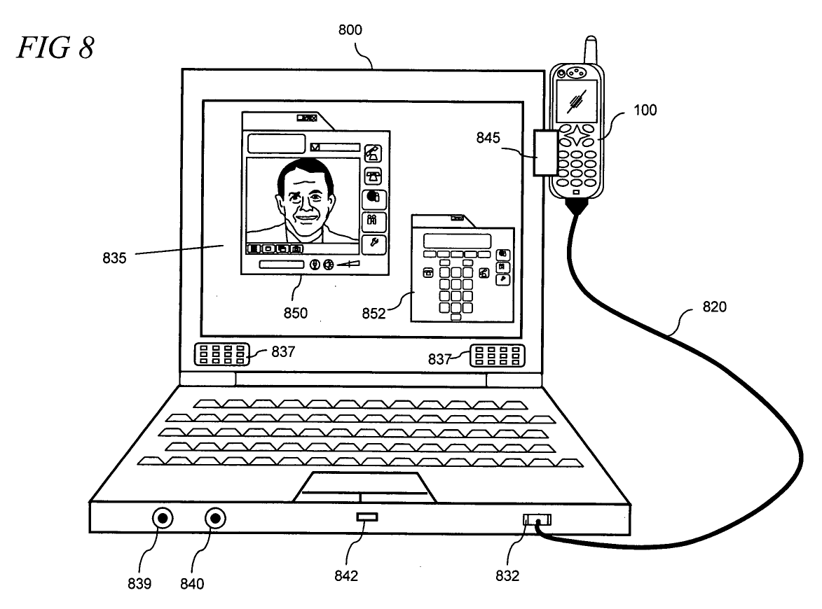

FIG. 8 is a simplified pictorial representation of the illustrative arrangement in which the mobile phone 100 is operatively connected to a laptop PC 800 (which hosts a videophone soft client as described below) using a cable 820. Laptop PC 800 includes a display screen 835, built-in speakers 837, a microphone input port 839, and an external speaker port 840, as shown. Laptop PC 800 also includes an internal microphone 842 that is oriented with an access opening in the front of the laptop PC 800.

In this illustrative example, cable 820 has a device connector 550 on one end which is coupled to the accessory connector 525 that is disposed in mobile phone 100. The other end of cable 820 is a connector which is plugged into a port 832 of laptop PC 800. In one example, such connector and port are arranged to be USB-compliant.

Mobile phone 100 is attached to display screen 835 of laptop PC 800 using an attachment device 845. Attachment device 845 is used to fixedly and removably hold mobile phone 100 in an appropriate spatial orientation with laptop PC 800 and a user that is using the laptop PC 800 (who is typically seated in front of the laptop PC 800). Attachment device 845 is typically formed from a lightweight material that clamps the body 136 of mobile phone 100 against the rigid frame surrounding display screen 835.

As shown in FIG. 8, camera 310 (FIG. 3) is pointed so as to capture a video image of the laptop PC user. In some applications, attachment device 845 is configured to provide a variable range of positions for mobile phone 100 relative to laptop PC 800 as may be needed to adjust the field of view of camera 310 to capture a desired view of the user seated in front of laptop PC 800.

A videophone soft client with a mobile phone interface runs on laptop PC 800. The videophone soft client is generally implemented completely in software and leverages the laptop PC's existing hardware, operating system software, and other applications to implement a video telephony session for the user. The videophone soft client manages, at a high (i.e., application) level, all of the hardware used to support video telephony (e.g., audio and video inputs and outputs using the laptop PC 800, mobile phone 100 and other peripheral equipment such as an external microphone) and implements all the necessary video call control functions with an external network and clients at the network endpoints. Call control (sometimes also called “call processing”) is used here to refer to the sequence of steps necessary to establish and route telephone calls from one endpoint to another in a network. The call control functionality implemented using the videophone soft client further include the provision of the call control features noted above, including hold, call transfer, mute, speed-dialing, phonebook dialing, buddy-list dialing, and three-way and conference calling and other commonly used features.

The videophone soft client running on laptop PC 800 also includes an application programming interface (“API”) to interact and support a GUI that displays windows 850 and 852 on display screen 835. Windows 850 and 852 provide the videophone end-user interface and provide simple “point and click” desktop management of the soft videophone that is enabled on laptop PC 800. Such management includes videophone operation, settings, and configuration of contact lists and phone books, to name just a few examples.

The API further optionally enables the videophone functionality provided by the soft client to be integrated with other applications operating on the desktop of the laptop PC 800. These include, for example, office suite programs, email and IM (instant messaging) clients and word processing programs.

Network access for videophone call transport and signaling is provided in several alternative manners. In many applications it is desirable to access a wireless data network using mobile phone 100. In this case, the videophone soft client interacts with the mobile phone so that the required bandwidth is provided using the mobile phone as a wireless data network modem. Various wireless data network types may be used to implement video telephony using a mobile phone interface including those listed at the end of this description.

In alternative arrangements, the required bandwidth is provided using the laptop PC 800 as a network access device. For example, Internet access may be provided using a dial-up connection or broadband connection through a broadband ISP (Internet service provider) that is typically available in a home setting, or through LAN (local area network) connection that may be available in a work setting.

Using the illustrative arrangement shown in FIG. 8 to set up a video telephony session is easy and convenient for a user. The user positions laptop PC 800 to comfortably see the display screen 835 and operate the controls displayed by GUI windows 850 and 852. The user clips mobile phone 100 to the laptop 800 using attachment device 845 and plugs cable 820 into the mobile phone 100 and USB port 832.

The user has several options in selecting and configuring the speaker and microphone hardware used in the soft videophone. For the speaker, speaker 135 (FIG. 1) in mobile phone 100 may be used in speakerphone mode, or the laptop PC's built-in speakers 837 are used. A user can also choose to use a headset that plugs into either the laptop PC's external speaker port 840 or the jack 243 in mobile phone 100 (FIG. 2). Lastly, a wireless headset (such as a Bluetooth headset) may be coupled to either the mobile phone 100 or laptop PC 800 in applications where those devices are equipped with short reach wireless transceivers.

For the microphone, the user may select from the internal microphone 132 (FIG. 1) in mobile phone 100 or the internal microphone 842 in laptop PC 800. An external microphone may also be plugged into microphone input port 839 in laptop PC 800 or jack 243 in mobile phone 100. A microphone that is integrated with a headset (either a wired or wireless headset) is also usable.

In some applications, the user employs a soft switch that is optionally enabled using the videophone soft client to selectively and functionally switch among the various peripheral devices described above. In other applications, such switching is performed automatically by existing hardware/software schemes on either the laptop PC 800 or mobile phone 100. For example, as with many laptop computers, laptop PC 800 typically automatically disables built-in microphone 842 is when an external microphone is plugged into its microphone input port 839. Similarly, mobile phone 100 is generally configured to automatically disable its internal microphone 132 and speaker 135, for example, when a 3-conductor combination headset and microphone is plugged into jack 243 (FIG. 2).

The user launches the videophone soft client on the laptop 800 to configure the hardware described above to meet the user's preferences and/or requirements and initiate and control a video telephony session. Such configuration control may include that associated with camera imaging characteristics (color bit depth, resolution, zoom etc.), audio characteristics and control associated with setting up the mobile phone 100 as a wireless modem, as described above, to access a wireless data network. Other camera settings that may be user-controllable in various applications are listed at the end of this description.

Network settings are user-selectable from such setting as modem settings, security settings and network proxy settings. Modem settings include, for example, hardware flow control, dialing strings, and port selection. Security settings typically include user names, logins and passwords, and enablement and disablement of filing sharing, for example. Network proxy settings typically include IP addresses necessary to enable access to secured enterprise or other private networks.

By interacting with the GUI windows 850 and 852 on the laptop PC 800, a user dials phone numbers or selects from a buddy-list or phonebook to make a videophone call or answer a videophone call. In addition, the user may take advantage of the various call control features provided by the videophone soft client as described in detail herein.

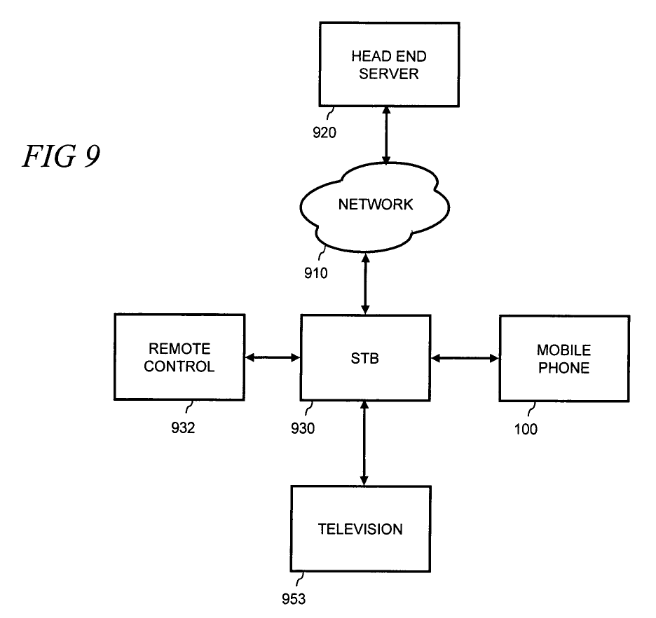

FIG. 9 is block diagram of an illustrative example of a client-server arrangement incorporating a head-end server 920, network 910, a set top box (“STB”) 930, remote control 932, mobile telephone 100 and television 953. Network 910 is used to couple the head-end server 920 to STB 930. In this illustrative arrangement, network 910 is a cable television network such as co-axial cable or hybrid fiber co-ax network. Alternative networks include satellite networks, telephone networks, data networks including local-, metropolitan-, and wide-area-networks (LANs, MANs, and WANs, respectively), and distributed networks such as the Internet. The head-end server 920 provides media content such as television programming over network 910 to STB 930 which displays the media content on the coupled television 953.

In many networks, both upstream and downstream bandwidth is provided to the network subscriber. Accordingly, STB 930 is configured in various alternative examples as an Internet portal using the television 953 and remote control 932 as the user interface. Head-end server 920 supplies digital data over network 910 to an electronic programming guide (“EPG”) application that typically resides within a middleware application in the STB 930. An EPG is an on-screen GUI hosted by the STB 930 on television 132 that facilitates television programming selection, interactions with electronic storefronts, Internet surfing, email and the like.

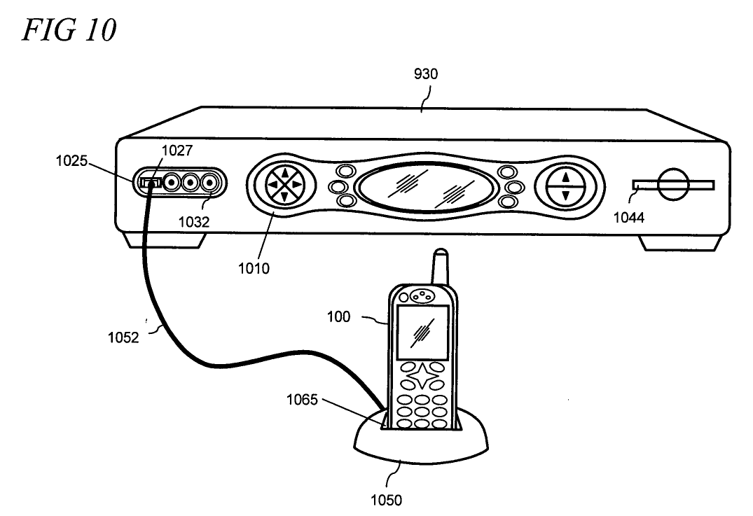

FIG. 10 is a simplified pictorial representation of an illustrative arrangement in which the mobile phone 100 is connected to the set top box 930 which is utilized to host a videophone soft client with a mobile phone interface. STB 930 is representative of current STBs which are specialized electronic devices that process information, generally in digital format. STBs typically function as a gateway between a user's television or personal computer and telephone, satellite, terrestrial or cable networks. STBs accept commands from a user (typically using remote control 932 as shown in FIG. 9) and transmit these commands back upstream to the network head end, through a back channel. The illustrative STB shown in FIG. 10 includes a front panel display 1010 with operating controls, an I/O panel 1025 including a front panel USB connector 1027 and three audio/video jacks 1032. STB 930 also includes a smart card slot 1044.

A mobile phone stand 1050 is used in this illustrative example which is physically separated from but operatively connectable to STB 930. As shown, mobile phone stand 1050 is coupled to a cable 1052 that is plugged into the data connector 1027 Cable 1052 uses a USB connector to interface with STB 930. Alternatively, cable 1052 interfaces with STB 930 using one of the connectors listed at the end of this description.

Mobile phone stand 1050 is arranged with an opening 1065 to position mobile phone 100 in a substantially upright position. In various applications, the opening is arranged vertically or sloped and the overall configuration (size, shape, etc) of the mobile phone holder 1050 is selected so that the mobile phone 100 is oriented in an appropriate position to capture video images in a video telephony setting.

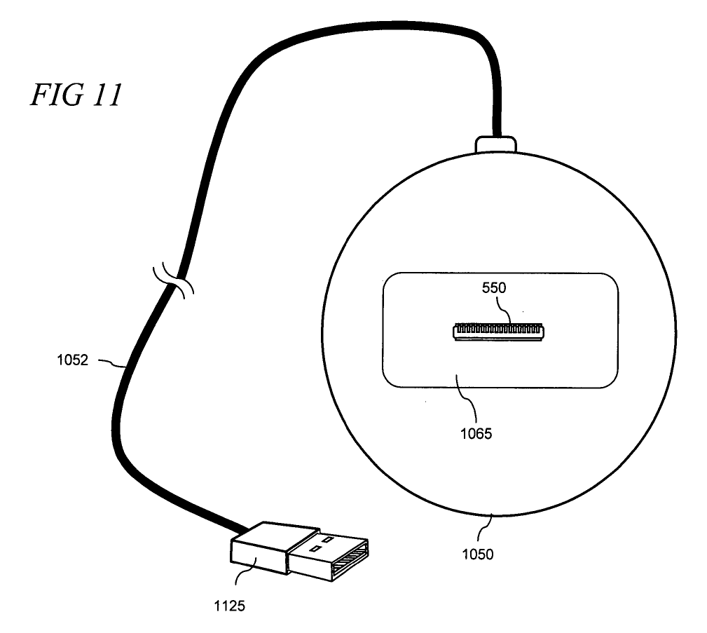

FIG. 11 is a top pictorial view of mobile phone stand 1050 showing that the device connector 550 (FIG. 5) is disposed at the bottom of the opening 1065. Device connector 550 is operatively connectable to the accessory connector 525 positioned on the bottom of mobile phone 100 as shown in FIG. 7 and described in the accompanying text. Cable 1052 is arranged to couple to device connector 550 and transmit signals between STB 930 (FIG. 9) and mobile phone stand 1050 through the USB plug 1125 and cable 1052.

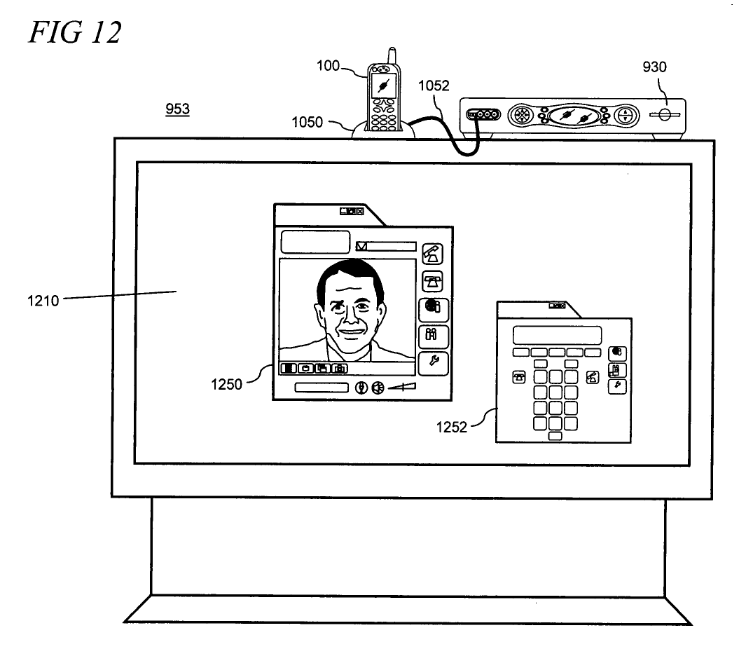

FIG. 12 is a simplified pictorial representation of the illustrative arrangement shown in FIGS. 10 and 11 as used with a television 953 (FIG. 9). As shown, mobile phone stand 1050 and mobile phone 100 are oriented to face a user (not shown) who is typically seated to view television 953. Mobile phone stand 1050 is operatively connected to STB 930 using cable 1052. A videophone soft client with a mobile phone interface runs on STB 930 in a similar manner as that described in the text accompanying FIG. 8. Accordingly, the videophone soft client running on STB 930 manages the hardware used to implement the soft videophone, performs call control and processing, and supports an end-user GUI.

End-user GUI windows 1250 and 1252 are displayed by the STB 930 on the screen 1210 of television 953. In a similar manner as shown in FIG. 8 and described in the accompanying text, windows 1250 and 1252 provide operating, set up and configuration management capabilities to the user. In most applications, the user interacts with the GUI using the remote control 932 (FIG. 9) which is selected from a variety of devices including a handheld remote control, keypad, voice recognition unit or keyboard.

Network access for videophone telephone calls is provided in the illustrative example shown in FIG. 12 through a wireless data network accessed using the mobile phone 100, or alternatively via network 910 (FIG. 9) that is coupled to STB 930.

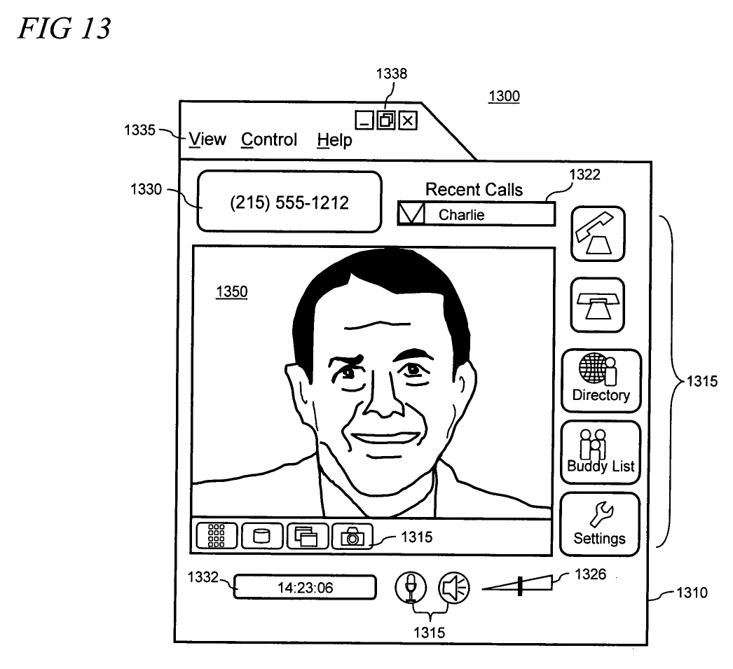

FIG. 13 is a simplified pictorial representation of an illustrative graphical user interface window 1300 that is used to facilitate user operation of the soft videophone. Similar GUI windows are shown with less detail in FIGS. 8 and 12. GUI window 1300 is presented to a user in a typical display window 1310 and includes various graphical controls such as buttons 1315, drop down lists 1322, sliders 1326, display areas 1330 and 1332, pull down menus 1335, window controls 1338, and the like that are used to present information to the user and provide user control over the soft videophone. Window 1300 is one example of what is typically included in a set of windows used to implement the end-user GUI that are generally arranged in a hierarchical manner.

In this illustrative example, buttons 1315 are used to perform various functions including initiating a dial tone (i.e., placing the videophone's virtual handset “off hook”), hanging up, and accessing phone books, buddy-lists, and settings (which may be displayed as additional separate windows), and other menus or controls used to operate the soft videophone. Display areas 1330 and 1332 provide textual and/or graphical feedback to the user such as the number being dialed, call status, clocks and timers, and the like. Other graphical controls such as the slider 1326 enables the user to set functions such as microphone input and/or speaker output levels. It is emphasized that these are just examples. The specific mix, selection and usage of the various graphical objects provided to implement the GUI is a matter of design choice that is dependent on the requirements of a specific soft videophone application.

GUI window 1300 also includes a video display area 1350 that is used to display the video from the remote endpoint of the videophone call. As shown, the video display area 1350 in window 1300 typically includes the video image (i.e., head and face) of the party at the remote endpoint.

The video image displayed on GUI window 1300 is rendered by videophone soft client using the electronic device's video processing capabilities. In most PCs, for example, a video hardware processor is implemented using dedicated hardware such as a video adapter (also called a video display board or card) which often includes onboard memory and graphic processors (often called graphic processors or co-processors). Accordingly, frame rates and image resolutions high enough to support television, DVD (digital versatile disc), and in some cases HD-quality (high definition) video are generally achievable in most PCs.

Set top boxes and many other electronic devices are also capable in some applications to process video very effectively. In other applications using a videophone soft client with mobile phone interface, it may be desirable to take advantage of the video encoding capabilities onboard the mobile. This may be particularly advantageous where a more advanced mobile phone is available. Accordingly, encoded video from mobile phone 100 is sent over cable 1052 (FIG. 12) in this instance.

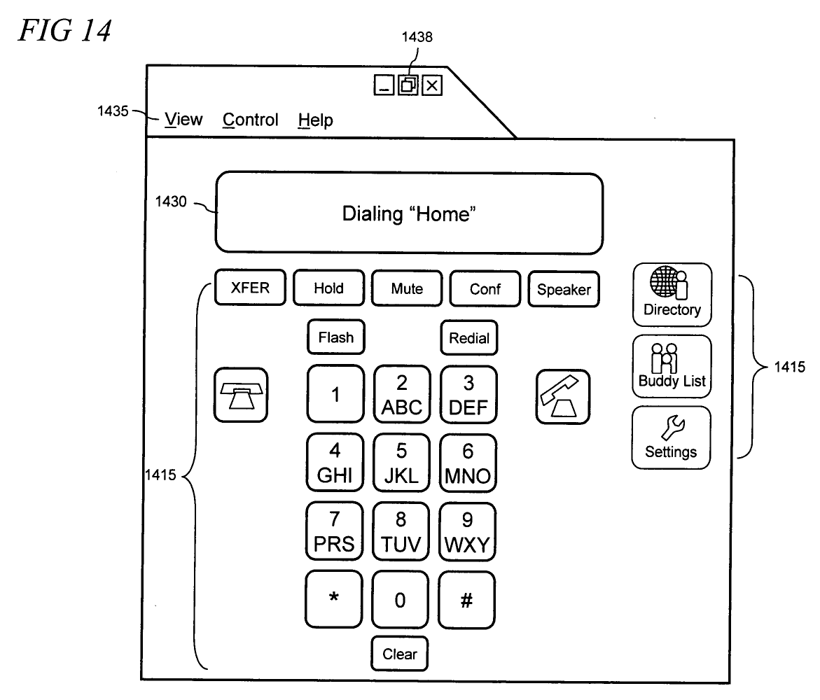

FIG. 14 is a simplified pictorial representation of another illustrative graphical user interface window 1400 that is used to facilitate user operation of the soft videophone. Similar GUI windows are shown with less detail in FIGS. 8 and 12. As with GUI window 1300, GUI window 1400 is presented to a user in a typical display window 1410 and includes various graphical controls such as buttons 1415, display areas 1430, pull down menus 1435, window controls 1438, and the like that are used to present information to the user and provide user control over the soft videophone. Window 1400 is another example of what is typically included in a set of windows used to implement the end-user GUI that are generally arranged in a hierarchical manner.

In the illustrative example shown in FIG. 14, buttons 1415 are used to perform various functions including initiating a dial tone (i.e., “off hook”), hanging up, and accessing phone books, buddy-lists, and settings (which may be displayed as additional separate windows), and other menus or controls used to operate the soft videophone. In particular, buttons 1415 are arranged to present a dialing keypad similar in appearance and operation to that provided by a hardware-implemented videophone.

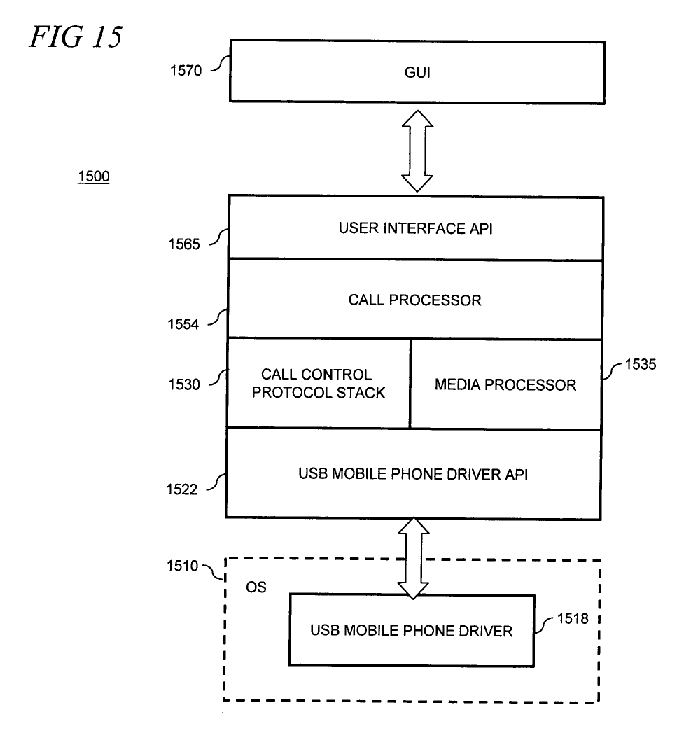

FIG. 15 is a diagram of an illustrative architecture for a videophone soft client 1500. Videophone soft client 1500 is alternatively arranged to run on a variety of electronic platforms including PCs, STBs, PDAs, pocket PCs and the like. Accordingly, videophone soft client 1500 is alternatively arranged to run using various operating systems (“OS”) as illustratively listed at the end of this description.

OS 1510 includes a mobile phone device driver, which in this illustrative example is a USB mobile phone driver 1518. USB mobile phone driver 1518 enables communication between OS 1510 and a mobile phone that is operatively coupled to the electronic device (that is running videophone soft client 1500) using the electronic device's USB bus. USB mobile phone driver 1518 and OS 1510 operate together to enable the videophone soft client 1500 to communicate to an endpoint in the mobile phone through a mobile phone driver API 1522 that is located on the bottom layer of videophone soft client 1500.

Typically, USB mobile phone driver 1518 is developed and supplied by a mobile phone vendor as such drivers are generally device-specific (although generic drivers are also usable in some applications depending on the requirements of a specific application). Accordingly, USB mobile phone driver 1518 can be expected to be commonly sold by mobile phone vendors, for example, as part of a connectivity package where it is bundled with hardware such as cable 852 (FIG. 8) and cable 1052 (FIG. 10). Such connectivity packages are commonly retailed for existing applications such as modem connections and file sharing.

In other applications, mobile phone drivers may be packaged on an original equipment basis and supplied to videophone soft client suppliers. In this case, the videophone soft client software package sold to the end-user would typically include a plurality of different mobile phone drivers where the specific driver is selected and installed by the user to match that user's specific model of mobile phone.

The interface between OS 1510 on the host device (e.g., laptop computer, set top box, etc.) and a mobile phone may be arranged in accordance with development guidelines and compliance programs from the USB-IF (USB Implementers Forum, Inc.) which is an organization that was founded by the group of companies that developed the USB specification. In particular, USB-IF publishes approved class specification documents that are usable to describe the USB interface employed to exchange video and audio information between the mobile phone and host device

An applicable audio specification is described by “Universal Serial Bus Device Class Definition for Audio Devices” Release 1.0, March 1998; “Universal Serial Bus Device Class Definition for Audio Data Formats” Release 1.0, Mar. 18, 1998; and “Universal Serial Bus Device Class Definition for Terminal Types” Release 1.0, Mar. 18, 1998. An applicable imaging specification is described by “Universal Serial Bus Still Image Capture Device Definition” Release 1.0, Jul. 11, 2000.

An applicable video specification is described by “Universal Serial Bus Device Class Definition for Video Devices” Revision 1.1, Jun. 1, 2005; Universal Serial Bus Device Class Definition for Video Devices: Video Device Examples” Revision 1.1, Jun. 1, 2005; “Universal Serial Bus Device Class Definition for Video Devices: Frequently Asked Questions (FAQ)” Revision 1.1, Jun. 1, 2005; “Universal Serial Bus Device Class Definition for Video Devices: Identifiers” Revision 1.1, Jun. 1, 2005; “Universal Serial Bus Device Class Definition for Video Devices: DV Payload” Revision 1.1, Jun. 1, 2005; “Universal Serial Bus Device Class Definition for Video Devices: Frame Based Payload” Revision 1.1, Jun. 1, 2005; “Universal Serial Bus Device Class Definition for Video Devices: Motion-JPEG Payload” Revision 1.1, Jun. 1, 2005; “Universal Serial Bus Device Class Definition for Video Devices: MPEG-2 TS Payload” Revision 1.1, Jun. 1, 2005; “Universal Serial Bus Device Class Definition for Video Devices: Stream Based Payload” Revision 1.1, Jun. 1, 2005; “Universal Serial Bus Device Class Definition for Video Devices: Uncompressed Payload” Revision 1.1, Jun. 1, 2005; and, “Universal Serial Bus Device Class Definition for Video Devices: Video Media Transport Terminal” Revision 1.1, Jun. 1, 2005.

The USB-IF documents noted above are available from a variety of sources including the organization's website:
http://www.usb.org/developers/devclass_docs

The next layer above mobile phone driver API 1522 in the videophone soft client 1500 includes a call control protocol stack 1530 and media processor 1535. Call control protocol stack 1530 manages the VoIP protocols used to control multimedia communications including voice and video telephony over packet-type networks such as the Internet. Depending on the requirements of a specific application of video telephony, different communication protocols are used by call control protocol stack 1530 including those complying with the ITU H.323 recommendation and SIP developed by the IETF which each define the fundamental call model used in a video telephony session.

Media processor 1535 processes the media to and from media devices used in a soft videophone including video that is rendered on the display of an electronic device that is running videophone soft client 1500, and associated the audio. Accordingly media processor 1535 includes a video codec to encode and decode video and audio data used in a video telephony session. A variety of video codecs may be used in media processor 1535 depending on the specific requirements of an application of video telephony. In this illustrative example, the video codec in media processor 1535 complies with the ITU H.264 recommendation. Alternative video codecs are listed at the end of this description.

Media processor 1535 optionally enables other functionalities associated with audio/video media including, for example, acoustic echo cancellation, automatic gain control and jitter compensation.

Call processor 1554 is the next layer in videophone soft client 1500 which sits above the call control protocol stack 1530 and media processor 1535. Call processor 1554 enables fundamental call control including how phone calls are set up, monitored, placed, answered, transferred, and conferenced, taken down, etc., on the soft videophone. Call processor 1554 also provides the user with the call control features noted above (e.g., hold, call transfer, mute, speed-dialing, phonebook dialing, buddy-list dialing, and three-way and conference calling, etc.).

A user interface API 1565 is used in this illustrative example for passing communication between the call processing layer in soft client 1500 and an end-user interface such as the GUI 1570 shown in FIG. 15. GUI 1570 may be arranged, for example, to display GUI windows including those shown in FIGS. 13 and 14 and described in the accompanying text. While GUI 1570 is arranged as a separate software module in this illustrative example, in other applications of video telephony, it may be desirable to directly embed the GUI application within the soft client 1500.

Various video formats may be used by the mobile phone camera to implement video telephony using the present soft client with mobile phone interface depending on the specific requirements of an application. Such video formats include 3GP, motion JPEG, MPEG-1, MPEG-2, MPEG-4, ITU H.261, ITU H.262, ITU H.263, AVI, QuickTime, RealMedia, RealVideo, DivX, WMV, USB OTG (On-The-Go) and ASF.

Various data interface formats may be used between the mobile phone and the electronic device used to host the present videophone soft client with mobile phone interface depending on the specific requirements of an application thereof. Such data interface formats include USB 0.9, USB 1.0, USB 1.1, USB 2.0, wireless USB, serial, parallel, network, BlueTooth, ZigBee, IR (infrared), UWB (Ultrawideband), magnetic and FireWire (i.e., IEEE 1394) interfaces.

Various cable connectors may be used to connect a mobile phone to an electronic device hosting a videophone soft client depending on the specific requirements of an application thereof. Such cable connectors include 6 MiniDin female (also called a “PS/2” connector commonly used on mouse and keyboard ports), 5 DIN female (used as keyboard connector on older PCs), 4 MiniDin female (commonly used as a keyboard and mouse connector for Apple® brand computers), 8 MiniDin female (commonly used as an AppleTalk® brand network connector), DB9 male (a common serial connector), high density DB15 female (commonly used as VGA or SVGA connector on PCs), DB 15 (commonly used as a joystick or game controller connector), DB25 female (commonly used as a parallel printer port on PCs), DB25 male (commonly used as serial port connector for RS-232 style peripherals), Centronics 50 female (an older style external SCSI connector), Half Pitch DB50 female (used as a SCSI2 connector), Half Pitch DB68 female (used as a SCS13 connector), USB Type A female (commonly used to connect USB peripherals) and USB Type Mini-AB female (used, for example with USB OTG).

Various wireless data networks may be used to implement video telephony using the present soft client with mobile phone interface depending on the specific requirements of an application thereof. Such wireless data networks include GPRS, WAP, UMTS, EV-DO, 2G, 2.5G, 3G, 4G, IDEN, TDMA, CDMA, PDC, 2G CDMA, WiFi, WiMAX, W-CDMA, GSM, EDGE, TD-SCDMA and CDMA2000.

Various camera settings and configurations may be user-controllable in conjunction with the videophone soft client including brightness, contrast, zoom, image resolution, white balance, color bit depth, saturation, color, focus, exposure compensation, video compression depth, video compression format and video frame rate

Various operating systems may be used to implement video telephony using the present soft client with mobile phone interface depending on the specific requirements of an application thereof. Such operating systems include Microsoft Windows™, Microsoft Windows Mobile, Microsoft Windows CE, OS/2, VMS, DOS, CP/M, UNIX, BSD (Berkeley Software Distribution), Linux, Mac OS, and System V.

Various codecs may be used to implement video telephony using the present soft client with mobile phone interface depending on the specific requirements of an application thereof. Such codecs include ITU H.261, ITU H.263, MPEG-1 part 2 (Moving Picture Experts Group), MPEG-2 part 2, ITU H.262, ITU H.263, MPEG-4 part 2, MPEG-4 part 10, AVC, WMV (Windows Media Video), RealVideo, DivX, XviD (and open source MPEG-4 codec), 3ixv and Sorenson 3 (used by Apple® Quicktime).

Each of the processes shown in the figures and described above may be implemented in a general, multi-purpose or single purpose processor. Such a processor will execute instructions, either at the assembly, compiled or machine-level, to perform that process. Those instructions can be written by one of ordinary skill in the art following the description contained herein and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

What is claimed is:

1. A computer-readable medium for enabling an electronic device to function as a soft videophone, the computer-readable medium carrying one or more sequences of instructions, which, when executed by one or more processors disposed in the consumer electronic device, cause the one or more processors to perform the processes of:
communicating with a mobile phone that is operatively coupled to the electronic device, the mobile phone having a built-in camera for capturing images; and
processing video to be rendered on a display, the video including images captured by the camera.

2. The computer-readable medium of claim 1 further including one or more additional instructions, which, when executed by the one or more processors, causes to the one or more processors to perform the process of:
establishing a connection with a network to transmit and receive video and audio signals over the network with remote videophones that are operatively connected with the network.

3. The computer-readable medium of claim 2 where the network is a wireless data network that is accessed using the mobile phone.

4. The computer-readable medium of claim 1 further including one or more additional instruction, which, when executed by the one or more processes, causes to the one or more processors to perform the process of:
processing audio captured by a microphone disposed in the mobile phone.

5. The computer-readable medium of claim 1 further including one or more additional instruction, which, when executed by the one or more processes, causes to the one or more processors to perform the process of:
generating a graphical user interface including graphical objects representing a plurality of user-selectable controls for operating the soft videophone.

6. The computer-readable medium of claim 1 where the communicating is performed using an communications interface, where the communication interface includes a plurality of different interfaces, the interfaces selected from USB 0.9, USB 1.0, USB 1.1, USB 2.0, wireless USB, serial, parallel, network, BlueTooth, ZigBee, IR, UWB, magnetic, USB OTG and FireWire interfaces.

7. The computer-readable medium of claim 5 where the plurality of user-selectable controls includes controls for videophone call control functions selected from one of: off hook, dial, redial, flash, hang up, speed dialing, buddy-list dialing, phonebook dialing, call hold, call transfer, call mute, three-way calling, conference calling, caller ID, speakerphone, speaker volume, microphone sensitivity and video/voice mail.

8. The computer-readable medium of claim 1 where the electronic device is selected from one of personal computers, laptop computers, personal digital assistants and set top boxes.

9. A graphical user interface for use in a processing device operable as a videophone, the processing device having at least one port that is operatively connectable with a mobile phone having a built-in camera, the graphical user interface comprising:
a settings component for displaying a first graphical object representing user-selectable controls for setting the camera to capture images for processing by the videophone; and
a user control component for displaying a second graphical object representing a plurality of user-selectable controls for operating the videophone.

10. The graphical user interface of claim 9 where the user-selectable controls for camera settings are selected from one of brightness, contrast, zoom, image resolution, white balance, color bit depth, saturation, color, focus, exposure compensation, video compression depth, video compression format and video frame rate.

11. The graphical user interface of claim 9 where the set up component further includes a third graphical object representing user-selectable settings for the mobile phone for connecting to a wireless data network.

12. The graphical user interface of claim 11 where the settings include a plurality of different settings, the settings selected from modem settings, security settings and network proxy settings.

13. A videophone soft client for running on a processing device, comprising:
a user interface API arranged to communicate with a user interface;
a device driver API arranged to interact with a mobile phone driver to receive video images captured from a camera built into a mobile phone; and
a call processor layer for providing video telephone call control features through the user interface API to a user.

14. The videophone soft client of claim 13 further including a call control protocol stack.

15. The videophone soft client of claim 14 where the call control protocol stack includes a plurality of different call control protocol stacks, the call control protocol stacks selected from ITU H.323, ITU H.248, SIP and MGCP.

16. The videophone soft client of claim 13 further including a media processor for processing the video images received from the mobile phone.

17. The videophone soft client of claim 16 where the media processor includes a video codec.

18. The videophone soft client of claim 16 where the media processor includes an audio codec.

19. The videophone soft client of claim 17 where the video codec conforms with ITU H.263.

20. The videophone soft client of claim 17 where the video codec conforms with ITU H.264.
